(19) United States
(12) Patent Application Publication
(10) Pub. No.: US 2008/0216274 A1
(43) Pub. Date: Sep. 11, 2008

(54) Wiping Device

(75) Inventors: Bruno Egner-Walter, Heilbronn (DE); Michael Schauble, Bietigheim-Bissingen (DE)

Correspondence Address: OSHA LIANG L.L.P., 1221 MCKINNEY STREET, SUITE 2800, HOUSTON, TX, 77010, US

(73) Assignee: VALEO SYSTEMES D'ESSUYAGE, Le Mesnil-Saint-Denis (FR)

(21) Appl. No.: 11/994,116

(22) PCT Filed: Jun. 29, 2006
(86) PCT No.: PCT/EP2006/006310

§ 371 Date: May 9, 2008

(30) Foreign Application Priority Data
Jun. 29, 2005 (DE) 10 2005 030 201.7

(51) Int. Cl. B60S 1/52; B60S 1/48; B60S 1/04

(52) U.S. Cl. 15/250.02

(57) ABSTRACT

A wiping device for vehicle windows including a wiper blade on at least one wiper arm, wherein the wiper blade is intended for an initial movement from a home position into a reversal position, and a return movement from the reversal position into the home position, and a spray device including numerous spray or nozzle openings, arranged successively in a longitudinal wiper blade direction and assigned to two longitudinal wiper blade sides, for ejecting a washing or cleaning fluid onto the vehicle window, wherein the spray device is formed so that after activation of the spray and wiping process, a greater quantity of washing or cleaning fluid is ejected on the longitudinal wiper blade side which leads in the initial movement, at least during the initial movement of the wiper blade, than on the longitudinal wiper blade side which follows in the initial movement and leads in the return movement.

The invention relates to a wiping device according to the preamble of Patent Claim 1 and therein, specifically, to a wiping device with a so-called “wet wiping blade”, having numerous spray or nozzle openings for introducing a washing or cleaning fluid onto a vehicle windshield. Some of these spray or nozzle openings are arranged along one side of the wiper blade, and some of them on the other side, and for this purpose, for instance partially, provided on the respective side of the wiper blade.

Such wet wiping blades/wiping devices with such wiper blades are known in various versions, such as DE 100 00 373, EP 1 209 050, EP 1 400 422). Another known form (DE 100 58 455) is the wiping device and/or its spray device which has spray or nozzle openings, formed such that selective closure of the spray or nozzle openings means that only those openings which lie in the wiping direction are opened; that is, those openings which are arranged on the side which is moving ahead, which is then obtained by—for instance—a more complex formation or shape of the wiping rubber/the rubber-elastic wiper strip.

The aim of the invention is to obtain improved wiping or cleaning quality with the thriftiest possible use of the washing or cleaning fluid. To reach this aim, a wiping device is formed according to Patent Claim 1.

In the wiping device according to the invention, with activation of the spray device, the windshield washing system or its pump, at least with the first movement of the wiper blade, that is, with the initial movement of the wiping blade from the home position in the direction from which it reverses its direction, a larger quantity of washing or cleaning fluid is ejected along the side of the wiper blade which is ahead of the other side in the wiper motion out of the spray or nozzle openings which are arranged on this wiper side, than on the other side of the wiper blade, which follows in the first movement and leads in the return movement (B).

In the sense of the invention, the “initial movement” is the movement of the wiper blade in the direction of the home position/reversal position, and the “return movement” is the movement in the direction of the reversal position/home position.

Furthermore, in the wiper device according to the invention, the wiper blade has at least one wiping rubber or wiping blade, already known per se, which lie against the vehicle windshield with at least one wiping lip and with this wiping lip, define a wiping blade plane which lies across the plane of the vehicle and includes the length of the wiper blade.

The spray or nozzle rays assigned to one longitudinal side of the wiper blade are, in the sense of the invention, such rays which strike the vehicle windshield on the same side of a wiper plane on which the corresponding longitudinal side of the wiping blade is also located. The spray or nozzle openings assigned to one longitudinal side of the wiper blade are therefore the nozzle openings which are assigned to such spray or nozzle rays.

The spray or nozzle openings which are assigned to one longitudinal side of the wiper blade are, for instance, provided on this longitudinal side of the wiper blade or arranged and oriented along the wiper blade such that the spray rays which are ejected from the spray or nozzle openings strike the vehicle windshield on the same side of the wiper blade plane on which the respective side of the wiper blade is provided.

Depending on the layout of the wiper device or the way/extent to which the vehicle windshield is dirty, it may be advantageous for effective cleansing when—in the course of the first one to five initial movements of the wiper blade or alternatively, with every initial movement of the wiper blade, that a greater quantity of washing or cleaning fluid is ejected out of the spray or nozzle openings which are arranged on the longitudinal side which leads in the initial movement, than on the side which follows in the initial movement and therefore leads in the return movement.

The ejection of the greater quantity of washing or cleaning fluid on the longitudinal side of the wiper blade which leads in the initial movement can be realized in various ways, as will be subsequently described.

Good cleaning results are obtained with thrifty use of cleaning fluid if the washing/cleaning solution is provided on both longitudinal sides of the wiper blade while the wiper blade, that is, the windshield washing system, is activated, so that rays of fluid are ejected on both longitudinal wiper sides both in the initial movement and in the return movement.

With particularly preferred embodiments of the invention, means for controlling the ejection of the washing or cleaning fluid depending on the direction of motion of the wiper blade/of at least one wiper arm are provided such that the washing or cleaning fluid is only ejected from the spray or nozzle openings which are located on the respective longitudinal side of the wiper blade that is currently moving ahead. This produces an even thriftier use of the washing fluid. Furthermore, obstruction of visibility which is otherwise caused by the washing or cleaning fluid ejected behind the wiper blade which is in motion across the windshield is avoided, thereby increasing traffic safety.

The invention is explained in the following with reference to the figures, using various embodiment examples. The following are shown:

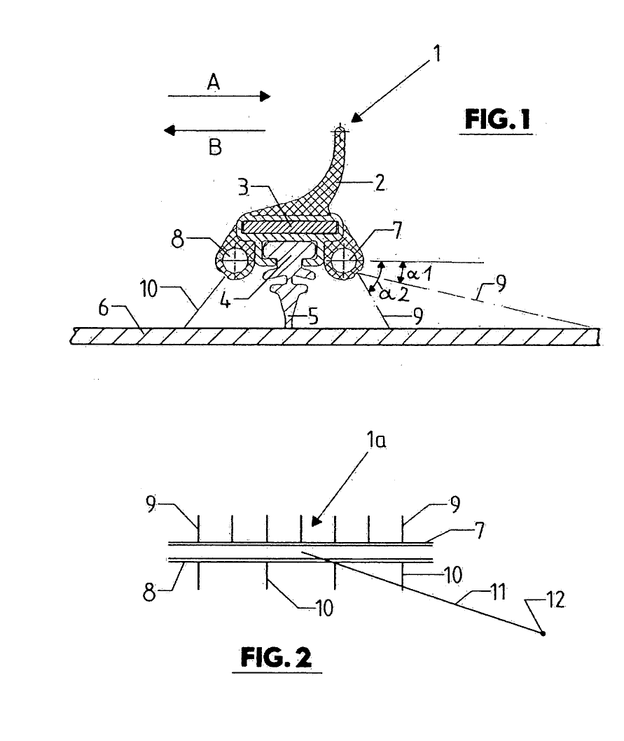

FIG. 1 a cross-section through a wiper blade, together with a vehicle window, for instance, a vehicle windshield;

FIG. 2-7 in simplified schematic views, various embodiments of a wiping device, consisting of a wiper blade and a wiper arm.

FIG. 1 shows 1 as a flat wiper blade with a spoiler in a windshield wiper arrangement, consisting of a wiper blade body 2 which forms the spoiler and is produced from two different synthetic material in the depicted embodiment, a spring rail 3 which is produced from spring steel and included in this wiper blade body 2, as well as a wiper blade 4 which is produced from a rubber-elastic material and rests against a vehicle window 6 with a wiper lip 5.

The wiper blade 1 is, for instance, held in the common manner with an adapter not shown in FIG. 1, on a wiper arm of the wiping device, both of which are also not shown in this figure.

In the wiper blade body 2, two spray or fluid channels 7 and 8 are formed, respectively one channel along each wiper blade side of the wiper blade 1 on the sides of the wiper strip 4. The fluid channels 7 and 8 are linked by means of a suitable, at least partially hose-formed connection to a source from which these channels are filled with a washing or cleaning fluid, namely water with possible additives, under pressure when the wiper system is operated/the spray process is activated.

When operating the wiping device, the wiper blade 1 is moved by the swinging wiper arm in an initial movement from a starting or home position or a position adjacent to this according to Arrow A of FIG. 1 in the direction of a turning position and in a return position from the turning position according to Arrow B in the direction of the home position. Herein, the right longitudinal side of the wiper blade in FIG. 1, which has the fluid channel 7, is that longitudinal side of the wiper blade which leads in the initial movement A, and the left longitudinal side of the wiper blade in FIG. 1 which has the fluid channel 8 is that longitudinal side of the wiper blade which follows in the initial movement A and leads in the return movement B.

The fluid channels 7 and 8 are, respectively, equipped with numerous successive spray or nozzle openings which are arranged along the longitudinal side of the wiper blade 1; namely the fluid channel 7 with spray or nozzle openings for ejection of liquid rays 9 of the washing or cleaning fluid, and the fluid channel 8 with spray or nozzle openings for ejection of liquid rays 10 of the washing or cleaning fluid. The rays of liquid are respectively bent at an angle towards the outer surface of the vehicle.

In order to obtain optimal cleaning or wiping results with the thriftiest possible use of the washing or cleaning liquid, particularly already during the first wipe across the vehicle window 6 with the wiper blade 1, that is, for instance, after activation of the spray device with the first movement of the wiper blade 1 from the home position into the reversal position and back from this position into the home position, this spray device which is formed by the fluid channels 7 and 8 and the respective spray or nozzle openings is formed so that after activation of the spray process, a larger quantity of washing or cleaning fluid is ejected onto the vehicle window out of the spray or nozzle openings along the wiper blade side which leads the other side in the initial wiper motion A, that is, from the spray or nozzle openings of the fluid channel 7, than out of the spray or nozzle openings which are arranged on the other side of the wiper blade, which follows in the initial movement A and leads in the return movement (B); that is, from the spray or nozzle openings of fluid channel 8.

For this purpose, for instance, the overall opening cross-section of the spray or nozzle openings of the fluid channel 7 is greater than the overall opening cross-section of the spray or nozzle openings of the fluid channel 8, which can be accomplished by a larger number of spray or nozzle openings or by a larger opening cross-section of the spray or nozzle openings on channel 7. Furthermore, there is the option of supplying the cleaning and washing fluid to the fluid channel 7 at least during the initial movement A with pressure which is higher than the pressure in the fluid channel 8. Various combinations of the previously named measures are also feasible.

Good cleaning results are obtained when the washing or cleaning fluid is ejected simultaneously from the openings on both longitudinal sides of the wiper blade both during the initial movement A and during the return movement B.

However, preference is given to embodiments of the invention in which the ejection of the fluid rays 9 and 10 takes place with dynamic control with the motion of the wiper blade 1/the wiper arm, namely such that during the initial movement A, the washing or cleaning fluid is only ejected from the spray or nozzle openings of the fluid channel 7 to form the fluid rays 9, and in the return movement B, washing or cleaning fluid is only ejected from the spray or nozzle openings of the fluid channel 8 to form the fluid rays 10, wherein furthermore, at least during the first initial movement A, the quantity of the ejected washing fluid is greater than the quantity of the washing fluid ejected during the return movement B. Control takes place, for instance, through a valve arrangement which is operated with the wiper arm. Other measures, such as the use of a controllable pump with a reversible direction of rotation for transporting the washing fluid, are also feasible.

Specifically, the fluid channel 7 in the embodiment shown in FIG. 1 has at least two groups of spray or nozzle openings whose fluid rays 9 strike the vehicle window 6 at differing angles α1 and α2, and which are arranged in the longitudinal direction of the wiper blade in alternate succession or in another arrangement.

FIGS. 2-7 show a simplified image of various embodiments of the wiping device according to the invention.

FIG. 2 shows a wiping device consisting of a wiper blade 1a and a wiper arm 11, wherein the wiper arm 11 carries the wiper blade 1a on one end, and whose other end is fastened at 12 to a shaft with a reversing drive 12 for the swinging or wiping motion.

The wiper blade 1a is, for instance, formed in accordance with the wiper blade 1, but definitely has spray or nozzle openings for forming the fluid rays 9 or 10 on both longitudinal wiper blade sides, wherein the number of spray or nozzle openings and therefore the number of fluid rays 9 on the longitudinal wiper blade side which leads in the initial movement A is greater than on the longitudinal wiper blade side which follows in the initial movement A and leads in the return movement B. The arrangement of the spray or nozzle openings is furthermore made so that—vertically to the longitudinal direction of the wiper blade 1a—one spray or nozzle opening for a fluid ray 10 lies opposite to a spray or nozzle opening 9; however, between every two successive spray or nozzle openings for the fluid rays 10, a further spray or nozzle opening is provided for a fluid ray 9. When activating the spray process, the quantity of the washing or cleaning fluid which is ejected on the wiper blade side which leads during the initial movement A is therefore greater than on the wiper blade side which leads during the return movement B.

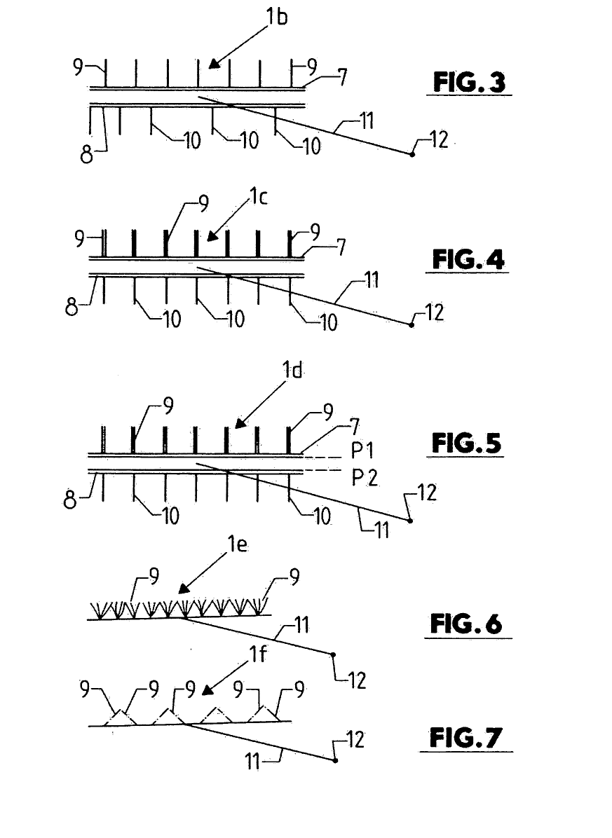

FIG. 3 shows a wiper device consisting of the wiper arm 11 and the wiper blade 1b. In this wiping device as well, the number of spray or nozzle openings on the longitudinal wiper blade side which leads in the initial movement A is greater than on the longitudinal wiper blade side which leads in the return movement B. This embodiment does, however, differentiate itself from the embodiment in FIG. 2 in that the spray or nozzle openings for the fluid rays 10 and the spray or nozzle openings for the fluid rays 9 are arranged so that they alternate, rather than being directly opposite each other.

Due to the large number of spray or nozzle openings for the fluid rays 9 and the shifted arrangement of the spray or nozzle openings, a particularly even distribution of the washing or cleaning fluid on the vehicle window 6 is obtained.

FIG. 4 shows a wiping device consisting of the wiper arm 11 and a wiper blade 1c, which differentiates itself from the wiper blade 1a in that each spray or nozzle opening for a fluid ray 10 lies opposite a spray or nozzle opening for a fluid ray 9; however, the spray or nozzle openings for the fluid rays 9 have a comparatively larger opening cross-section than the spray or nozzle openings for the fluid rays 10. In this embodiment, when the spray process is activated, the quantity of the washing or cleaning fluid which is ejected via the spray or nozzle openings on the longitudinal wiper blade side which leads in the initial movement A is therefore greater than on the longitudinal wiper blade side which leads in the return movement B.

FIG. 5 shows a wiping device consisting of the wiper arm 11 and the wiper blade 1d. In this embodiment, the fluid channel 7 which is assigned to the fluid rays 9 is supplied with the washing or cleaning fluid—at least during the initial movement A—with a pressure P1 which is greater than the pressure P2 in the fluid channel 8 which is assigned to the fluid rays 10, so that this alone, even with an equal opening cross-section of the spray or nozzle openings, means that a greater quantity of washing or cleaning fluid is ejected onto the vehicle window 6 on the longitudinal wiper blade side which leads in the initial movement, than on the longitudinal wiper blade side which leads in the return movement B.

FIG. 6 shows a further possible embodiment of a wiping device with a wiper blade 1e and a wiper arm 11. FIG. 6 shows only the fluid rays 9. The respective spray and nozzle openings on the longitudinal wiper blade side which leads in the initial movement A are formed in this embodiment so that the fluid rays 9 form so-called wide or fan rays and strike the vehicle window in this form, so that the washing or cleaning fluid is applied particularly evenly onto the vehicle window 6 along this longitudinal wiper blade side.

FIG. 7 shows a further possible embodiment in the form of a wiping device which consists of the wiper arm 11 and the wiper blade 1f. In this figure as well, only the spray or fluid rays 9 which are ejected on the longitudinal wiper blade side which leads in the initial movement A are shown. Through corresponding formation and orientation of the spray or nozzle openings, the fluid rays 9 are formed as so-called point rays and oriented to each other such that at least, respectively, two fluid rays 9 collide with each other prior to striking the vehicle window 6, thereby forming a kind of droplet fog due to which the washing or cleaning fluid is distributed as evenly as possible on the vehicle window 6.

In FIGS. 6 and 7, the shown embodiments are like the other embodiments in that the quantity of washing or cleaning fluid ejected on the longitudinal wiper blade side which leads in the initial movement A is greater than on the longitudinal wiper blade side which leads in the return movement B.

Specifically in the description of FIG. 1, it was assumed that two spray or fluid channels 7 and 8 are provided. Fundamentally, it is also possible to supply the spray or nozzle openings which generate the fluid rays 9 and 10 via a single, joint channel that transports the washing and cleaning fluid, or to provide more than two fluid channels—for instance, two such channels with their respective spray or nozzle openings on the longitudinal wiper blade side of the respective wiper blade which leads in the initial movement A.

The invention was described above using exemplary embodiments. It is understood that numerous other changes and variations, and particularly also combinations of the precedingly named exemplary embodiment are feasible, without departing from the invention idea upon which the invention is based.

For instance, it is possible to arrange the spray or nozzle openings on the longitudinal wiper blade side which leads in the return movement so that the fluid rays are ejected onto the vehicle window at different angles, and/or to arrange the spray and nozzle openings so that the angle of the fluid rays is generally different on both longitudinal wiper blade sides.

### LIST OF REFERENCE SYMBOLS

1, 1a-1f Wiper blade
2 Wiper blade body
3 Spring rail
4 Wiper rail
5 Wiper lip
6 Vehicle window
7, 8 Spray or fluid channel
9, 10 Spray or fluid ray
11 Wiper arm
12 Shaft
A, B Direction of movement of the wiper blade
P1, P2 Pressure
α1, α2 Ejection angle of the fluid rays referred to a plane parallel to the vehicle window

1. A wiping device for vehicle windows, comprising:
a wiper blade on at least one wiper arm, wherein the wiper blade is intended for an initial movement from a home position into a reversal position, and a return movement from the reversal position into a direction of the home position; and
a spray device comprising numerous spray or nozzle openings which are arranged successively in a longitudinal wiper blade direction and assigned to two longitudinal wiper blade sides, for the purpose of ejection of a washing or cleaning fluid onto the vehicle window,
wherein the spray device is formed so that after activation of the spray and wiping process, a greater quantity of washing or cleaning fluid is ejected on the longitudinal wiper blade side which leads in the initial movement, at least during a first initial movement of the wiper blade, than on the longitudinal wiper blade side which follows in the initial movement and leads in the return movement.

2. The wiping device according to claim 1, wherein the spray device is formed so that after activation of the spray and wiping process, and during the first initial movement and a subsequent four initial movements, of the wiper blade, the quantity of washing or cleaning fluid ejected along the longitudinal wiper blade side which leads in the initial movement is greater than on the longitudinal wiper blade side which follows the initial movement and leads in the return movement.

3. The wiping device according to claim 1, wherein the spray device is formed so that after activation of the spray and wiping process, during every initial movement of the wiper blade, the quantity of washing or cleaning fluid which is ejected along the longitudinal wiper blade side which leads in this initial movement is greater than on the longitudinal wiper blade side which follows in the initial movement and leads in the return movement.

4. The wiping device according to claim 1, wherein the number of spray or nozzle openings which are arranged on the longitudinal wiper blade side which leads in the initial movement is greater than the number of spray and nozzle openings which are arranged on the longitudinal wiper blade side which leads in the return movement.

5. The wiping device according to claim 1, wherein an overall opening cross-section of the spray or nozzle openings which are arranged on the longitudinal wiper blade side which leads in the initial movement is larger than an overall opening cross-section of the spray or nozzle openings which are arranged on the longitudinal wiper blade side which leads in the return movement.

6. The wiping device according to claim 5, wherein at least a part of the spray or nozzle openings which are arranged on the longitudinal wiper blade side which leads in the initial movement has a larger opening cross-section than the spray or nozzle openings which are arranged on the longitudinal wiper blade side which leads in the return movement.

7. The wiping device according to claim 1, further comprising:
means for supplying the spray or nozzle openings which are arranged on the longitudinal wiper blade side that leads in the initial movement with washing or cleaning fluid at a greater pressure than the spray or nozzle openings which are arranged on the longitudinal wiper blade side that leads in the return movement.

8. The wiping device according to claim 1, further comprising:
means for controlling the ejection of the washing or cleaning fluid in dependency on the direction of motion of the wiper blade, or the at least one wiper arm, such that the washing or cleaning fluid is, respectively, ejected only from those spray or nozzle openings which are arranged on the longitudinal wiper blade side that leads in the respective motion.

9. The wiping device according to claim 1, wherein each spray or nozzle opening which is arranged on the longitudinal wiper blade side that leads in the return movement is, vertically to the longitudinal axis of the wiper blade side, opposed by a nozzle opening which is arranged on the longitudinal wiper blade side that leads in the initial movement.

10. The wiping device according to claim 9, wherein further spray or nozzle openings are arranged on that longitudinal wiper blade side which leads in the initial movement, in addition to such spray or nozzle openings which, respectively, lie opposite one of the spray or nozzle openings that are arranged on the other longitudinal wiper blade side.

11. The wiping device according to claim 1, wherein at least a number of those spray or nozzle openings which are provided on the longitudinal wiper blade side which leads in the initial movement are arranged in alternate positions to the spray or nozzle openings on the other longitudinal wiper blade side.

12. The wiping device according to claim 1, wherein at least some spray or nozzle openings which are arranged on the longitudinal wiper blade side which leads in the initial movement, are formed so as to eject fluid rays in the form of wide or fan shaped rays.

13. The wiping device according to claim 1, wherein at least some of the spray or nozzle openings which are arranged on the longitudinal wiper blade side which leads in the initial movement, are formed and oriented so that they eject fluid rays, preferably point rays, which are directed so that they collide with each other.

14. The wiping device according to claim 1, wherein the spray or nozzle openings are, at least mostly, arranged along the two longitudinal wiper blade sides or near these longitudinal sides.

15. The wiping device according to claim 1, wherein the spray or nozzle openings are formed and oriented so that they form fluid rays which strike the vehicle window at or below an angle.

16. The wiping device according to claim 1, wherein the spray or nozzle openings which are arranged on the longitudinal wiper blade side which leads in the initial movement, form at least two groups whose fluid rays strike the vehicle window at differing angles.

17. The wiping device according to claim 1, wherein the wiper blade comprises at least two spray or fluid channels wherein the at least two spray or fluid channels comprise at least one separate spray or fluid channel for the spray or nozzle openings which are arranged on the longitudinal wiper blade side that leads in the initial movement, and at least one specific spray or fluid channel for the spray or nozzle openings which are arranged on the longitudinal wiper blade side which leads in the return movement.

18. The wiping device according to claim 1, wherein the wiper blade comprises at least one joint spray or fluid channel for the spray or nozzle openings which are arranged on the longitudinal wiper blade side that leads in the initial movement and for the spray or nozzle openings which are arranged on the longitudinal wiper blade side that leads in the return movement.

19. The wiping device according to claim 1, wherein the vehicle window is a windshield or rear window of a road vehicle.

20. The wiping device according to claim 1, wherein the wiper blade is formed as a flat wiper blade.

21. The wiping device according to claim 1, wherein at least one spray or fluid channel and the associated spray or nozzle openings, are provided in a wiper blade body on which at least one wiper rail is provided, wherein the at least one wiper rail forms at least one wiper lip made from a rubber-elastic material.
